(19) United States
(12) Patent Application Publication
(10) Pub. No.: US 2022/0394994 A1
(43) Pub. Date: Dec. 15, 2022

(54) LOW WATER ACTIVITY MARSHMALLOW

(71) Applicant: THE HERSHEY COMPANY, Hershey, PA (US)

(72) Inventors: Xiaoying WANG, Hummelstown, PA (US); Michael NOLT, Elizabethtown, PA (US)

(21) Appl. No.: 17/756,371

(22) PCT Filed: Dec. 10, 2020
(86) PCT No.: PCT/US2020/064245

§ 371 Date: May 24, 2022

Related U.S. Application Data
(60) Provisional application No. 62/947,015, filed on Dec. 12, 2019.

(51) Int. Cl. A23G 3/42; A23G 3/52; A23G 3/44; A23G 3/54; A21D 13/80

(52) U.S. Cl. CPC A23G 3/42; A23G 3/52; A23G 3/44; A23G 3/54; A21D 13/80; A23V 2002/00

(57) ABSTRACT

A process of preparing a marshmallow piece includes preparing a pre-cook syrup batch of a mixture including a low viscosity saccharidic composition, humectant, and water as a pre-cook syrup batch. The low viscosity saccharidic composition includes at least two low viscosity saccharidic components and at least one polysaccharide. The process also includes cooking the pre-cook syrup batch to form a cooked syrup composition having a predetermined moisture content, combining the cooked syrup composition with a gelatin solution and optionally at least one flavoring to form a pre-whip marshmallow composition, whipping the pre-whip marshmallow composition to form a whipped marshmallow composition having a predetermined density, and forming and setting up a formed marshmallow composition to form the marshmallow piece. The marshmallow has a water activity in the range of between 0.40 and 0.45. A comestible includes the marshmallow and at least one dry portion having a crunchy texture.

### CROSS-REFERENCE TO RELATED APPLICATIONS

This application claims priority to and the benefit of U.S. Provisional Application No. 62/947,015, filed Dec. 12, 2019, which is hereby incorporated by reference in its entirety.

### FIELD OF THE INVENTION

This application is directed to low water activity marshmallows, compositions including low water activity marshmallows, and methods of preparing low water activity marshmallows.

### BACKGROUND OF THE INVENTION

Marshmallows are traditionally made from sugar, corn syrup, gelatin, and water added to hydrate the gelatin, dissolve the sugar, and reduce the viscosity of the resulting mixture for proper whipping and aeration. As a result, conventional marshmallow formulations made by conventional methods have a water activity of greater than 0.65 or 0.75. As a result, when conventional marshmallows are part of a comestible in which they are in contact with a dry component, such as, for example, a cookie or cracker, moisture from the conventional marshmallow may, over time, cause the dry part to have a less desirable taste or texture upon consumption, thereby reducing the shelf life or overall quality of the comestible. For example, a cookie or cracker as the dry part may lose its crunchiness or even become soggy.

It would be desirable to provide a low water activity marshmallow retaining the taste and texture of a conventional marshmallow.

It would be desirable to provide a marshmallow product retaining the taste and texture of a conventional marshmallow while having a reduced water activity such that the marshmallow product may be included in a comestible including a dry part without detracting from the taste and texture of the dry part.

### BRIEF DESCRIPTION OF THE INVENTION

In an embodiment, a marshmallow includes an aerated mixture formed from a pre-whip composition including a low viscosity saccharidic composition, a humectant, gelatin, and water. The low viscosity saccharidic composition includes at least two low viscosity saccharidic components and at least one polysaccharide. The aerated mixture has a water activity in the range of between 0.40 and 0.45.

In another embodiment, a comestible includes a marshmallow and at least one dry portion having a crunchy texture. The marshmallow includes an aerated mixture formed from a pre-whip composition including a low viscosity saccharidic composition, a humectant, gelatin, and water. The low viscosity saccharidic composition includes at least two low viscosity saccharidic components and at least one polysaccharide. The marshmallow has a water activity in the range of between 0.40 and 0.45.

In yet another embodiment, a process forms a marshmallow piece. The process includes preparing a pre-cook syrup batch of a mixture including a low viscosity saccharidic composition, a humectant, and water as a pre-cook syrup batch. The low viscosity saccharidic composition includes at least two low viscosity saccharidic components and at least one polysaccharide. The process also includes cooking the pre-cook syrup batch to form a cooked syrup composition having a predetermined moisture content. The process further includes combining the cooked syrup composition with a gelatin solution and optionally at least one flavoring to form a pre-whip marshmallow composition and whipping the pre-whip marshmallow composition to form a whipped marshmallow composition having a predetermined density. The process also includes forming and setting up a formed marshmallow composition having a predetermined shape from the whipped marshmallow composition, thereby forming the marshmallow piece. The marshmallow piece has a water activity in the range of between 0.40 and 0.45.

Other features and advantages of the present invention will be apparent from the following more detailed description of exemplary embodiments that illustrate, by way of example, the principles of the invention.

### DETAILED DESCRIPTION OF EXEMPLARY EMBODIMENTS

Exemplary embodiments are directed to marshmallows having a low water activity less than 0.45, typically in the range of 0.40 and 0.45.

Among the advantages of certain exemplary embodiments are a low moisture content marshmallow, a low water activity marshmallow, a process of forming a marshmallow shape or piece free of a drying step after whipping and forming, a marshmallow combinable with a dry component such as a cookie or cracker, or any combination thereof, while still maintaining a taste, texture, appearance, and a consistency similar to a conventional marshmallow.

Exemplary embodiments are directed to low water activity marshmallows achieved without drying after whipping the pre-whip marshmallow composition and forming the whipped marshmallow composition into predetermined shapes or pieces.

Some exemplary embodiments are directed to comestibles including low water activity marshmallows that do not negatively affect the crispiness or crunchiness of a dry part of the comestible.

Exemplary embodiments employ a low viscosity saccharidic composition, which may include monosaccharides, disaccharides, and/or sugar alcohols, in amounts selected to provide a marshmallow composition that is whippable while having a moisture content in the range of about 14% to about 17% by weight at whipping or about 10% to about 14% by weight after whipping, well less than traditional processes which have a moisture content of 16% to 20% or higher by weight after whipping and forming.

The term “low viscosity saccharidic composition”, as used herein, refers to a saccharidic portion of a pre-cook syrup batch, where low viscosity saccharidic components make up, by dry weight, about 45% or greater, such as, for example, about 80% or greater, of the total saccharidic content. The term “low viscosity saccharidic component”, as used herein, refers to all monosaccharides, disaccharides, and saccharide-derived sugar alcohols. The term “total saccharidic content”, as used herein, refers to all monosaccharides, disaccharides, sugar alcohols, and polysaccharides, including starch and fiber.

The term “whippable”, as used herein, refers to being capable of incorporating air upon whipping to reach a bulk density of about 0.6 g/mL or less, such as, for example, a bulk density of about 0.5 g/mL or less. The whippability of a particular pre-whip marshmallow composition may depend on its viscosity, the type of whipping apparatus being used, the amount of gelatin in the composition, and the whipping temperature. In some embodiments, the whipping apparatus is a whisk. In some embodiments, the whipping apparatus is a paddle. In some embodiments, the whipping apparatus is an aeration machine.

A low water activity marshmallow was achieved by whipping a pre-whip marshmallow composition including a low viscosity saccharidic composition, glycerin, and gelatin without drying after the whipping and forming.

In exemplary embodiments, a marshmallow includes an aerated mixture including a low viscosity saccharidic composition, glycerin, gelatin, and water. The aerated mixture has a water activity in the range of between 0.40 and 0.45, alternatively between 0.40 and 0.44, alternatively between 0.41 and 0.45, alternatively between 0.41 and 0.44, alternatively 0.41, alternatively between 0.42 and 0.45, alternatively between 0.42 and 0.43, alternatively 0.42, alternatively 0.43, alternatively 0.44, alternatively 0.45, or any value, range, or sub-range therebetween.

A pre-cook syrup batch includes about 74% to about 78% dry weight solids, alternatively about 75% to about 77% dry weight solids, alternatively about 76% dry weight solids from a low viscosity saccharidic composition, glycerin, and any other solid ingredients. The pre-cook syrup batch, without the glycerin, includes about 59% to about 73% dry weight solids, alternatively about 59% to about 64% dry weight solids, alternatively about 64% to about 68% dry weight solids, alternatively about 69% to about 74% dry weight solids, or any value, range, or sub-range therebetween.

In exemplary embodiments, the low viscosity saccharidic composition is selected in combination with the other ingredients to provide a pre-whip marshmallow composition that is whippable down to a workable viscosity at a moisture content, preferably in the range of about 14% to about 17% by weight at whipping after addition of the gelatin solution or about 10% to about 14% by weight after whipping, to form the low water activity marshmallow.

In exemplary embodiments, the solubility, taste, effect on water activity, and viscosity at whipping are taken into consideration when selecting the type and amount of low viscosity saccharidic components and any other saccharides for a pre-whip marshmallow composition. In general, smaller molecules, such as low molecular weight saccharides, such as monosaccharides and disaccharides, provide a lower viscosity upon dissolution, and permit a higher solids content to suppress water activity, but larger molecules, such as polysaccharides, help to avoid crystallization of the smaller molecules during whipping.

In exemplary embodiments, the low viscosity saccharidic composition includes at least two low viscosity saccharidic components. An appropriate amount of the at least two low viscosity saccharidic components, by dry weight, of the total saccharidic content, is about 45% or greater, alternatively about 45% to about 95%, alternatively about 50% to about 80%, alternatively about 60% to about 95%, alternatively about 70% to about 95%, alternatively about 80% or greater, alternatively about 80% to about 95%, alternatively about 95% or less, or any value, range, or sub-range therebetween.

In exemplary embodiments, the at least two low viscosity saccharidic components include at least one monosaccharide. An appropriate amount of the at least one monosaccharide, by dry weight, of the total saccharidic content, is about 20% or greater, alternatively about 20% to about 90%, alternatively about 20% to about 50%, alternatively about 50% or less, alternatively about 20% to about 40%, alternatively about 40% to about 60%, alternatively about 60% to about 80%, alternatively about 80% to about 90%, alternatively about 50% to about 90%, or any value, range, or sub-range therebetween.

In some embodiments, the at least two low viscosity saccharidic components include at least one sugar alcohol. An appropriate amount of the at least one sugar alcohol, by dry weight, of the total saccharidic content, is about 5% or greater, alternatively about 5% to about 30%, alternatively about 5% to about 10%, alternatively about 10% to about 15%, alternatively about 15% to about 20%, alternatively about 10% to about 25%, alternatively about 20% to about 25%, alternatively about 25% to about 30%, alternatively about 30% or less, or any value, range, or sub-range therebetween.

In exemplary embodiments, the low viscosity saccharidic composition includes at least one polysaccharide. An appropriate amount of the at least one polysaccharide, by weight, of the total saccharidic content, is about 5% or greater, alternatively about 5% to about 30%, alternatively about 30% or less, alternatively about 5% to about 15%, alternatively about 5% to about 25%, alternatively about 15% to about 30%, alternatively about 20% to about 30%, or any value, range, or sub-range therebetween.

The total saccharidic content of the marshmallow includes monosaccharides, disaccharides, sugar alcohols, and polysaccharides that may be provided in either a solid form or a liquid form, such as a syrup. In exemplary embodiments, a pre-whip marshmallow composition includes low molecular weight saccharidic components that come from at least one low viscosity saccharidic syrup.

The low viscosity saccharidic syrup used in the formulation may include one or more monosaccharides, disaccharides, invert sugar syrups, and/or low viscosity sugar alcohol solutions, such as, for example, a sorbitol solution. In exemplary embodiments, a saccharidic syrup includes at least one low viscosity saccharidic component. Appropriate low viscosity syrups and sugar alcohol solutions may include, but are not limited to, invert sugar syrup, high fructose corn syrup, liquid sugar, allulose syrup, sorbitol solution, xylitol solution, and/or maltitol syrup. In exemplary embodiments, the saccharidic syrups include at least one saccharidic syrup containing larger molecular weight saccharides, such as maltotriose or other polysaccharides. Appropriate saccharidic syrups may include, but are not limited to, corn syrups, such as, for example, 63 dextrose equivalent (DE) corn syrup, high maltose corn syrup, or soluble fiber solutions, such as, for example, polydextrose solutions, inulin solutions, or corn fiber solutions.

The viscosity of a saccharidic syrup may be determined based on the monosaccharide and disaccharide composition of the syrup or solution or the monosaccharide and disaccharide composition in, for example, a soluble fiber solution. As noted above, the small molecules (monosaccharides and disaccharides) provide a lower viscosity and have a greater effect on the water activity reduction. In some embodiments, a low viscosity saccharidic syrup includes monosaccharides and disaccharides that, as a percentage of the total saccharide content by weight, is in the range of about 45% to 100%, such as, for example, about 80% to 100%. In some embodiments, a high viscosity saccharidic syrup includes maltotriose and other polysaccharides that, as a percentage of the total saccharide content by weight, is greater than about 55%. In some embodiments, a high viscosity saccharidic syrup may be included in the pre-cook syrup batch at a lower level, such as, for example, between about 5% and about 20%, by weight, of the pre-cook syrup batch, such that the saccharidic composition as a whole in the pre-cook syrup batch is a low viscosity saccharidic composition.

An appropriate total dry weight of monosaccharides in a low viscosity saccharidic composition, in combination, of a pre-cook syrup batch is in the range of about 20% to about 50%, alternatively about 25% to about 45%, alternatively about 30% to about 40%, alternatively about 33% to about 37%, alternatively about 35%, or any value, range, or sub-range therebetween.

It will be appreciated that the specific combination of liquid sugars and low viscosity saccharidic syrups and their relative amounts may be selected to provide any desired balance of taste and sweetness in addition to the finished texture to the low water activity marshmallow while also having sufficient solubility and contributing to the formation of a pre-whip marshmallow composition having a viscosity sufficiently low to be whippable. For example, invert sugar, a combination of fructose and dextrose, is sweet and its dextrose may crystallize at high solids such that its use needs to be balanced. Allulose, however, is less sweet than invert sugar and has a higher solubility than dextrose. In some embodiments, sugar alcohols or their solutions, such as, for example, a sorbitol solution may be used.

Exemplary embodiments further use at least some solid monosaccharides and/or disaccharides, such as sucrose, glucose, and/or fructose, as low molecular weight saccharides, in amounts that may be up to about 30% by dry weight of the pre-cook batch, such as about 20% or about 25% by dry weight sucrose. Solid sugar alcohols, such as, for example, sorbitol, xylitol, and/or maltitol, may be provided in place of their liquid form. This helps further contribute to high amounts of low molecular weight saccharidic components in the pre-cook syrup batch.

An appropriate total dry weight of the low molecular weight saccharidic components, which include all monosaccharides, disaccharides, and sugar alcohols, in combination, of a pre-cook syrup batch is in the range of about 45% to about 70%, alternatively about 55% to about 65%, alternatively about 58% to about 62%, alternatively about 60%, or any value, range, or sub-range therebetween.

Higher viscosity syrups or solutions, such as solutions of corn syrup solids or starch, having components of larger size molecules, such as polysaccharides, may also be present from about 3 to about 10% by dry weight of the pre-cook batch. Other soluble fiber syrups or solutions, such as, for example, inulin, polydextrose, soluble corn fiber, or isomaltulose syrup, may also be used. Corn syrup solids and soluble fiber solutions inhibit sugar crystallization at high solids, which may be advantageous for achieving a texture-stable product.

The amounts of sucrose and high maltose syrup may be selected to balance sweetness and finished texture.

In exemplary embodiments, a humectant, such as, for example, glycerin, is also added to the pre-cook syrup batch that also includes the sugars, low viscosity saccharidic syrups, and sugar alcohols, and aids in reducing the water activity of the end product. Appropriate amounts of glycerin or other humectant in the pre-cook syrup batch depend, in part, on the total amount of sugars and sugar alcohols in the pre-cook syrup batch. In exemplary embodiments, the amount of humectant in the pre-cook syrup batch, by weight, is in the range of about 5% to about 15%, alternatively in the range of about 5% to about 10%, alternatively in the range of about 5% to about 6%, alternatively in the range of about 6% to about 8%, alternatively in the range of about 10% to about 15%, or any value, range, or sub-range therebetween.

An appropriate balance of saccharidic components and glycerin provides a low water activity marshmallow with a desired taste and texture. When low amounts of the low viscosity saccharidic components are used in a formulation, which includes about 20% or less by dry weight of the pre-cook batch, a higher level of glycerin, such as, for example, about 15% by weight, may be included to bring the water activity down, but this may negatively impact the taste of the end marshmallow. On the other hand, at high amounts of the low viscosity saccharidic components and high levels of glycerin, such as, for example about 70% or more, in combination, by dry weight of the pre-cook batch, with decreased relative amounts, such as, for example, about 5% or less, of polysaccharides from saccharidic syrups, like high maltose syrup, the marshmallow may not set up properly as temperature decreases, making the marshmallow too soft/sticky. Additionally, when there are not enough large molecules from saccharidic syrups, for example, corn syrups, to inhibit sugar crystallization, oversaturation of monosaccharides or disaccharides, like dextrose from invert sugar or added sucrose, may lead to crystallization of the monosaccharides or disaccharides, resulting in an undesired texture.

In exemplary embodiments, other additives such as salt, preservatives, and flavorings (e.g., vanilla, vanillan, etc.) may also be added either as part of the pre-cook batch formulation and/or to the post-cooked material prior to aeration.

In exemplary embodiments, gelatin or other structuring agent is added to the cooked syrup prior to whipping to help with the body, texture and density of the finished product.

In exemplary embodiments, a process for forming a low-water activity marshmallow includes batching the pre-cook syrup mass, which may include added water in addition to moisture content of the ingredients, and then cooking the pre-cook syrup batch to form a cooked syrup having a predetermined moisture content. In some embodiments, the cooking may reduce the moisture content of the pre-cooked batch from about 20% to about 30% by weight to a predetermined moisture content in the range of about 12% to about 14%, alternatively in the range of about 12.5% to about 13.5%, alternatively about 12%, alternatively about 13%, alternatively about 14%, or any value, range, or sub-range therebetween. In exemplary embodiments, the cooking is at or to a temperature in the range of about 250° F. to about 260° F. (about 121° C. to about 127° C.), alternatively about 250° F. (about 121° C.), alternatively about 250° F. to about 255° F. (about 121° C. to about 124° C.), alternatively about 251° F. to about 254° F. (about 122° C. to about 123° C.), alternatively about 252° F. to about 253° F. (about 122° C. to about 123° C.), alternatively about 255° F., (about 124° C.) or any value, range, or sub-range therebetween.

In exemplary embodiments, the pre-cook syrup batch includes sufficient low viscosity saccharidic components to provide a cooked syrup with a viscosity low enough to be whippable at the whipping temperature when combined with a gelatin solution and any flavoring to form a pre-whip marshmallow composition. The ingredient combination allows the pre-whip marshmallow composition to be whippable down to a workable viscosity at a moisture content, preferably in the range of about 14% to about 17% by weight at the start of whipping and about 10% to about 14% by weight after whipping, that is lower than the whippable range of a pre-whip composition in a conventional marshmallow-forming process, which is in the range of 16% to 20% or higher by weight of the marshmallow product after whipping and forming.

The cooked syrup is combined with a gelatin solution and any flavoring to form a pre-whip marshmallow composition. In exemplary embodiments, the pre-whip marshmallow composition has a moisture content in the range of about 14% to about 17%, alternatively about 14%, alternatively about 14.5% to about 16.5%, alternatively about 14.5%, alternatively about 15% to about 16%, alternatively about 15%, alternatively about 15.5%, alternatively about 16%, alternatively about 16.5%, or any value, range, or sub-range therebetween.

In exemplary embodiments, the gelatin solution introduced into the cooked syrup includes a pre-hydrated gelatin in the medium bloom range of about 125 to about 250 bloom, alternatively about 150 to about 250 bloom, alternatively about 150 to about 225 bloom, alternatively about 150 to about 200 bloom, alternatively about 170 bloom, or any value, range, or sub-range therebetween. The gelatin solution may be pre-made by pre-hydrating the gelatin in water at a concentration in the range of about 30% to about 45%, by weight. Appropriate dry amounts of the gelatin in the pre-whip marshmallow composition depend, in part, on the bloom number of the gelatin used. Appropriate dry amounts of the gelatin, by weight, may be in the range of about 1.3% to about 4%, alternatively, about 1.3% to about 3%, alternatively about 1.5% to about 2%, alternatively about 1.8%, or any value, range, or sub-range therebetween.

In exemplary embodiments, the pre-whip marshmallow composition is whipped or aerated at a predetermined whipping temperature to form a whipped marshmallow composition having a predetermined density. The pre-whip marshmallow composition may be whipped or aerated with a whisk or paddle for benchtop scale or with a continuous aeration machine such as a Mondomix system (Haas-Mondomix B. V. Corp., Almere, NL) for larger scale production. An appropriate whipping temperature is in the range of about 130° F. to about 180° F. (about 54° C. to about 82° C.), alternatively about 135° F. to about 145° F. (about 57° C. to about 63° C.), alternatively about 135° F. (about 57° C.), alternatively in the range of about 138° F. to about 142° F. (about 59° C. to about 611° C.), alternatively about 138° F. (about 59° C.), alternatively about 140° F. (about 60° C.), alternatively about 142° F. (about 61° C.), alternatively about 145° F. (about 63° C.), or any value, range, or sub-range therebetween. In some embodiments, the predetermined density is in the range of about 0.5 g/mL to about 0.6 g/mL, alternatively about 0.5 g/mL, alternatively in the range of about 0.52 g/mL to about 0.58 g/mL, alternatively about 0.52 g/mL, alternatively about 0.55 g/mL, alternatively about 0.58 g/mL, alternatively about 0.6 g/mL, or any value, range, or sub-range therebetween.

In addition to introducing air into the composition, the whipping lowers the moisture content of the composition, as moisture evaporates from the composition during whipping at the whipping temperature.

In exemplary embodiments, the whipped marshmallow composition has a moisture content in the range of about 10% to about 14%, alternatively about 10%, alternatively about 10.5% to about 13.5%, alternatively about 11%, alternatively about 11% to about 13%, alternatively about 11%, alternatively about 12%, alternatively about 13%, alternatively less than 14%, or any value, range, or sub-range therebetween.

The whipped marshmallow composition may be deposited in a starch mould and set up at about room temperature and about 35% to about 40% relative humidity for about 18 to about 24 hours to allow the gelatin to set, thereby forming pre-shaped low water activity marshmallow pieces. Alternatively, the whipped marshmallow may be extruded onto a belt dusted with starch or a starch/dextrose blend and cooled in a continuous cooling tunnel and then cut into pieces having a predetermined shape. Alternatively, the whipped marshmallow may be sheeted with a dust of starch or powdered sugar and set up at about room temperature and about 40% relative humidity for about 18 to about 24 hours and then cut into pieces. An appropriate room temperature is in the range of about 65° F. to about 75° F. (about 18° C. to about 24° C.), alternatively about 67° F. to about 73° F. (about 19° C. to about 23° C.), alternatively about 68° F. to about 72° F. (about 20° C. to about 22° C.), alternatively about 70° F. (about 21° C.), or any value, range, or sub-range therebetween. In exemplary embodiments, there is no active drying step after whipping the pre-whip marshmallow composition and forming the whipped marshmallow composition. The finished marshmallow may be cut into pieces, if desired. In exemplary embodiments, the finished marshmallow has a moisture content in the range of about 10% to about 14%, alternatively about 10% to about 11%, alternatively about 10% to about 12%, alternatively about 11% to about 13%, alternatively about 11% to about 12%, alternatively about 12% to about 13%, alternatively about 12% to about 14%, alternatively about 13% to about 14%, or any value, range, or sub-range therebetween. In exemplary embodiments, the finished marshmallow has a water activity in the range of between 0.40 and 0.45.

The low water activity marshmallow may be used or included in a variety of comestible products. In exemplary embodiments, the low water activity marshmallow is part of a comestible product also including a dry part, such as a cookie or cracker, having a crispy or crunchy texture. The marshmallow may be separated from, in contact with, or directly or indirectly adhered to the dry part. In some embodiments, the comestible is a s'more-type comestible including the low water activity marshmallow adhered to a graham cracker and enrobed in chocolate.

### EXAMPLE

The invention is further described in the context of the following example, which is presented by way of illustration, not of limitation.

A pre-cook syrup batch was formed from sucrose, a sorbitol solution, invert sugar syrup, allulose syrup, high maltose syrup, salt, water, and glycerin in the relative amounts shown in Table 1. The ingredients were combined and mixed to form a homogeneous pre-cook syrup batch. The pre-cook syrup batch had a total dry weight of low viscosity saccharidic components from low viscosity syrups and sugar alcohol solutions (i.e., invert sugar, allulose syrup, and sorbitol solution) of about 34.7% with respect to the total weight of the pre-cook syrup batch, which was about 45.8% on a total dry weight basis.

TABLE 1
Pre-cook ingredients

| Ingredient | Solids (%) | Wt. (%) | Calculated Dry (%) |
|---|---|---|---|
| Sucrose | 99.9 | 25.44 | 25.41 |
| Sorbitol, 70% | 70.0 | 12.50 | 8.75 |
| Invert sugar | 70.0 | 23.15 | 16.21 |
| Allulose syrup, 77% | 77.0 | 12.50 | 9.63 |
| High maltose syrup | 80.0 | 12.60 | 10.08 |
| Salt (NaCl) | 100.0 | 0.22 | 0.22 |
| Water | 0.0 | 8.30 | 0.00 |
| Glycerin | 100.0 | 5.29 | 5.29 |
| TOTAL | | 100.00 | 75.58 |

The pre-cook syrup batch was cooked to a temperature of about 252 to 253° F. (about 122 to about 123° C.) to a moisture content of about 14%. The cooked syrup composition was cooled and mixed with hydrated gelatin and vanilla to form a pre-whip marshmallow composition. The pre-whip marshmallow composition included 94.94% cooked syrup, 5.00% hydrated gelatin, and 0.06% vanilla, by weight. The hydrated gelatin was a 40% by weight solution of 170 bloom kosher gelatin in water. The pre-whip marshmallow composition had a moisture content of 16.49%. The pre-whip marshmallow composition was whipped at about 140° F. (about 60° C.) to form a whipped marshmallow composition having a density in the range of about 0.50 g/mL to about 0.54 g/mL, such as, for example, about 0.52 g/mL.

The whipped marshmallow composition was deposited into a starch mould, and set up at about 70° F. (about 21° C.) and about 35% relative humidity for about 18 to 24 hours to form a low water activity marshmallow, with no further drying step after forming and setting up. The final moisture content of the low water activity marshmallow was in the range of about 10.0% to about 10.4% and the water activity was about 0.42 to about 0.44.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A marshmallow comprising:
an aerated mixture formed from a pre-whip composition comprising a low viscosity saccharidic composition, humectant, gelatin, and water;
wherein the low viscosity saccharidic composition comprises at least two low viscosity saccharidic components and at least one polysaccharide;
wherein the aerated mixture has a water activity in the range of between 0.40 and 0.45.

2. The marshmallow of claim 1, wherein the at least two low viscosity saccharidic components comprise at least one sugar alcohol.

3. The marshmallow of claim 1, wherein the at least two low viscosity saccharidic components comprise at least one monosaccharide.

4. The marshmallow of claim 1, wherein at least 5% by weight of a total saccharidic content of the pre-whip composition is the at least one polysaccharide.

5. The marshmallow of claim 1, wherein the composition further comprises at least one flavoring.

6. The marshmallow of claim 1, wherein the aerated mixture has a moisture content in the range of about 10% to about 12%. The marshmallow of claim 1, wherein the aerated mixture has a density in the range of about 0.50 g/mL to about 0.54 g/mL.

8. The marshmallow of claim 1, wherein the humectant is glycerin.

9. A comestible comprising:
a marshmallow comprising an aerated mixture formed from a pre-whip composition comprising a low viscosity saccharidic composition, humectant, gelatin, and water, wherein the low viscosity saccharidic composition comprises at least two low viscosity saccharidic components and wherein the marshmallow has a water activity in the range of between 0.40 and 0.45; and
at least one dry portion having a crunchy texture.

10. The comestible of claim 9, wherein the at least one dry portion is selected from the group consisting of a cracker and a cookie.

11. The comestible of claim 9, wherein the at least two low viscosity saccharidic components comprise at least one sugar alcohol.

12. The comestible of claim 9, wherein the at least two low viscosity saccharidic components comprise at least one monosaccharide.

13. The comestible of claim 9, wherein at least 5% by weight of a total saccharidic content of the pre-whip composition is the at least one polysaccharide.

14. The comestible of claim 9, wherein the aerated mixture has a moisture content in the range of about 10% to about 12%.

15. The comestible of claim 9, wherein the aerated mixture has a density in the range of about 0.50 g/mL to about 0.54 g/mL.

16. The comestible of claim 9, wherein the humectant is glycerin.

17. A process of preparing a marshmallow piece, the process comprising:
preparing a pre-cook syrup batch of a mixture comprising a low viscosity saccharidic composition, humectant, and water, wherein the low viscosity saccharidic composition comprises at least two low viscosity saccharidic components and at least one polysaccharide;
cooking the pre-cook syrup batch to form a cooked syrup composition having a predetermined moisture content;
combining the cooked syrup composition with a gelatin solution and optionally at least one flavoring to form a pre-whip marshmallow composition;
whipping the pre-whip marshmallow composition to form a whipped marshmallow composition having a predetermined density;
forming and setting up a formed marshmallow composition having a predetermined shape from the whipped marshmallow composition, thereby forming the marshmallow piece, the marshmallow piece having a water activity in the range of between 0.40 and 0.45.

18. The process of claim 17, wherein the at least two low viscosity saccharidic components comprise at least one sugar alcohol.

19. The process of claim 17, wherein the at least two low viscosity saccharidic components comprise at least one monosaccharide.

20. The process of claim 17, wherein at least 5% by weight of a total saccharidic content of the pre-whip marshmallow composition is the at least one polysaccharide.

21. The process of claim 17, wherein the process occurs without a drying step after the forming.

22. The process of claim 17, wherein the cooking is at a temperature in the range of about 250° F. to about 260° F.

23. The process of claim 17, wherein the pre-whip marshmallow composition has a moisture content in the range of about 14% to about 17%.

24. The process of claim 17, wherein the whipping is at a temperature in the range of about 130° F. to about 180° F.

25. The process of claim 17, wherein the predetermined density is in the range of about 0.50 g/mL to about 0.54 g/mL.

26. The process of claim 17, wherein the pre-whip marshmallow composition further comprises the at least one flavoring.

27. The process of claim 17, wherein the marshmallow piece has a moisture content in the range of about 10% to about 12%.

28. A marshmallow piece formed by the process of claim 17.
